(19) United States
(12) Patent Application Publication
(10) Pub. No.: US 2025/0347710 A1
(43) Pub. Date: Nov. 13, 2025

(54) ANEMOMETER HAVING A CARBON NANOTUBE FIBER HOT-WIRE PROBE

(71) Applicant: Max-Planck-Gesellschaft zur Förderung der Wissenschaften e.V., München (DE)

(72) Inventors: Eberhard Bodenschatz, Göttingen (DE); Antonio Alfredo Ibanez Landeta, Göttingen (DE)

(73) Assignee: Max-Planck-Gesellschaft zur Förderung der Wissenschaften e.V., München (DE)

(21) Appl. No.: 19/276,204

(22) Filed: Jul. 22, 2025

Related U.S. Application Data
(63) Continuation-in-part of application No. PCT/EP2024/051402, filed on Jan. 22, 2024.

(30) Foreign Application Priority Data
Jan. 23, 2023 (DE) 10 2023 101 582.6

(51) Int. Cl. G01P 1/00; G01P 5/12

(52) U.S. Cl. CPC G01P 1/00; G01P 5/12

(57) ABSTRACT

An anemometer has two prongs, each prong having a prong tip, and a hot-wire probe attached to the two prong tips and made of a section of a carbon nanotube fiber having an electric resistivity of not more than 25 μΩ·m and a positive thermal coefficient of resistivity of at least 1·10⁻³/K. Over an active length extending between the two prong tips, the hot-wire probe consists of the carbon nanotube fiber, and ends of the section of the carbon nanotube fiber extending along the prong tips are soldered to the prong tips.

### CROSS REFERENCE TO RELATED APPLICATIONS

This application is a continuation-in-part of International Application No. PCT/EP2024/051402 entitled “Anemometer having a carbon nanotube fiber hot-wire probe” filed on Jan. 22, 2024 and claiming priority to German Patent Application No. DE 10 2023 101 582.6 also entitled “Anemometer having a carbon nanotube fiber hot-wire probe” and filed on Jan. 23, 2023, the disclosures of which are incorporated herein by reference in their entirety.

### FIELD OF THE INVENTION

Various embodiments relate to an anemometer having a hot-wire probe, the hot-wire probe comprising a section of a carbon nanotube (CNT) fiber. Further, various embodiments relate to a method of producing such an anemometer.

### BACKGROUND OF THE INVENTION

Anemometer having hot-wire probes, i.e., so-called hot-wire anemometers, are well-known tools for measuring flow velocities of fluids in a variety of applications. A hot-wire anemometer uses a heated wire positioned within a fluid, such as a gas or a liquid, as a probe. When the fluid flows over the hot-wire probe, heat is transferred from the hot-wire probe to the fluid, cooling the hot-wire probe. The flow velocity can be determined from the temperature variation effects on the hot-wire probe.

Hot-wire anemometers have two basic operation modes. The first one is a constant current mode. In this mode an electric current through the hot-wire probe is kept constant. When the fluid takes heat away from the hot-wire probe, the temperature of the hot-wire probe decreases, and the greater the flow velocity, the lower the temperature of the hot-wire probe. When the temperature of the hot-wire probe changes, the resistance of the hot-wire probe and, as a result, a voltage between the ends of the hot-wire probe change as well. Thus, the flow velocity can be measured. The second one is a constant temperature mode. In this mode, the current through the hot-wire probe is varied to keep the temperature of the hot-wire probe constant. The greater the flow velocity, the greater the current that is needed to maintain the original temperature. Thus, the flow velocity can be measured by the current needed to keep the temperature of the hot-wire probe constant. Both modes are based on the relationship between temperature and resistance of the hot-wire probe. That is, the greater the effect of temperature on resistance of the hot-wire probe, the higher the sensitivity of the hot-wire anemometer.

The spatial resolution of a hot-wire anemometer, i.e., the capability of measuring different flow velocities for different locations in a flow field, depends on the length of the hot-wire probe. The temporal resolution of a hot-wire anemometer, i.e., the capability of measuring transient flow velocities for different points in time, depends on the mass, i.e., on the diameter, of the hot-wire probe. Thus, rather short and particularly thin hot-wire probes are of particular interest. Such thin hot-wire probes however, tend to be sensitive to the impacts of particles carried along with the fluid flowing over the hot-wire probe, or even to the forces applied to the hot-wire probes by the flowing fluid due to the flow resistance of the hot-wire probes.

U.S. Pat. No. 9,696,335 discloses a hot-wire anemometer utilizing metal-coated carbon nanotube wire in a hot-wire probe. The hot-wire probe consists of a carbon nanotube composite wire. The carbon nanotube composite wire includes a carbon nanotube wire, sometimes referred to as a carbon nanotube yarn, and a metal layer. The carbon nanotube wire includes a plurality of carbon nanotubes spirally arranged along an axial direction of the carbon nanotube wire. The diameter of the carbon nanotube wire is claimed to range from 50 nm to 30 μm. The metal layer is coated on a surface of the carbon nanotube wire. The thickness of the metal layer ranges from 50 nm to 5 μm. The material of the metal layer is a metal or a metal alloy with good conductivity, such as gold, silver or copper. The conductivity of the entire carbon nanotube composite wire is about 50 to 75% of the conductivity of the metal depending on the thickness of the metal layer. Because the carbon nanotube wire has good heat resistance, even if the metal layer is fused by high temperature, the carbon nanotube wire will not easily break, which allows the carbon nanotube composite wire to maintain an electrical connection. Further, the mechanical strength of the carbon nanotube wire is 5 to 10 times stronger than the mechanical strength of gold wire of the same diameter. Therefore, the durability of the hot wire and hot wire anemometer is improved, and the life of the hot wire and the hot wire anemometer is also increased. The carbon nanotube composite wire exhibits an electrical skin effect, the main current being conducted through the metal layer of the carbon nanotube composite wire. Therefore, the electrical conductivity of the carbon nanotube composite wire which is based on its outer metal layer is significantly improved. The comparatively thin outer metal layer is subject to abrasion in abrasive flows. This abrasion will reduce in a quick degradation of the hot-wire anemometer. Further, the metal-coated carbon nanotube wire is a custom product resulting in high cost of the known hot wire anemometer.

D. Wang et al.: Highly sensitive hot-wire anemometry based on macro-sized double-walled carbon nanotube strands, Sensors 2017, 17, 1756 disclose a flow-rate sensor with carbon nanotubes as sensing elements. The sensor uses a micro-sized centimeters long double-walled carbon nanotube strand as a hot-wire probe to sense fluid velocity. The flow sensor is assembled by suspending the double-walled carbon nanotube strand directly onto tungsten prongs and dripping a small amount of silver glue onto each contact between the strand and the prongs. The flow sensor made of the double walled carbon nanotube strand and having a diameter of about 20 μm exhibits an electric resistance of about 1 to 10 kΩ and a thermal coefficient of resistivity of 1.980·10⁻³/K. Further, the temperature coefficient of resistance is positive like that one of a metal. The double walled carbon nanotube strand based flow sensor has a better sensitivity than a sensor having the same strand coated with platinum. Once platinum was deposited on the double walled carbon nanotube strand, the dominating hot-wire probe in the hot-wire anemometer was diverted to platinum because of its lower resistivity.

M. Scholz et al.: Systematic investigations of annealing and functionalization of carbon nanotube yarns, Molecules, 2020 March; 25 (5): 1144 report that the electrical conductivity of carbon nanotube yarns can be increased by a factor of 2 and 5.5 through functionalization with acids and high temperature annealing, respectively. The scale of the enhancement is dependent on the reducing of intertube space in case of functionalization. For annealing, not only is a highly graphitic structure of the carbon nanotubes important, but it is also shown to influence the residual amorphous carbon in the structure. The authors assume that the results of their study can help to utilize carbon nanotube yarns as a replacement for common materials in the field of electrical wiring. More specifically, the authors present figures showing monotonically increasing conductivity with temperature. Further, the electrical conductivity increases over the whole temperature range with increasing annealing temperature. The acid treated carbon nanotube yarn also displays an increase of electrical conductivity with increasing temperature. Thus, the temperature coefficients of resistance are negative like that one of a semi-conductor in both cases. The carbon nanotube yarns investigated were produced by a two-step dry spinning process from a multi-walled carbon nanotube array.

N. Behabtu et al.: Strong, light, multifunctional fibers of carbon nanotubes with ultrahigh conductivity, Science 339, 182 (2013) disclose multifunctional carbon nanotube fibers combining the terminal conductivity of carbon fibers with a specific electrical conductivity of metals. The fibers consist of bulk-grown carbon nanotubes and are produced by high-throughput put wet spinning. The carbon nanotubes are dissolved in chlorosulfonic acid in order to form a spinnable liquid crystal dope. The dope is extruded through a spinneret into a coagulant to remove the acid. The forming filament is collected onto a winding drum. The fibers are further washed in water and dried in an oven. The fibers display a high electrical conductivity of about 3 MS/m at room temperature. Doping by iodine increases the conductivity to 5 MS/m. However, annealing the iodine doped carbon nanotube fibers at 600° C. reduces the electrical conductivity by an order of magnitude to 0.4 MS/m. Further, annealing strongly reduces a positive thermal coefficient of resistivity of the iodine doped carbon nanotube fibers and may even convert it into a negative coefficient of resistivity.

L. W. Taylor et al.: Improved properties, increase production, and the path to broad adoption of carbon nanotube fibers, Carbon, volume 171, January 2021, pages 689-694 report solutions spun carbon nanotube fibers with an electrical conductivity of more than 10 MS/m.

DexMat, Houston, Texas, USA, commercially offers carbon nanotube fibers, see https://store.dexmat.com. One of these carbon nanotube fibers called “Galvorn CNT-HS Fiber 20 microns” is a 20 micron diameter single filament fiber that is not twisted, plied, or braided. The claimed electric conductivity of this carbon nanotube fiber is 7±1 MS/m, see https://store.dexmat.com/galvorn-cnt-hs-fiber-20-microns/. More generally, see https://blog.dexmat.com/cnt-twisted-yarns, these single filament fibers range in size from 10 microns to around 100 microns in diameter, and the CNTs that compose them are densely packed and highly aligned along the fiber axis. The (relatively) high density and high degree of alignment achievable in this format allows it to achieve high values in many of the material properties we look for in CNT fibers, including tensile modulus, electrical conductivity, and thermal conductivity.

According to further information provided by DexMat, see https://blog.dexmat.com/temperature-dependence-and-temperature-limits-of-galvorn-cnt-products, Galvorn fibers, like many structures composed of an aggregation of CNTs, contain both metallic and semiconducting CNT types. While the metallic CNTs form enough of the structure to impart fairly good metallic conductivity, the semiconducting CNTs would not normally allow electrons to flow through them and would therefore normally act as ‘dead weight’ as far as the conductivity of the material is concerned. This situation changes if the semiconducting CNTs are electrically doped, allowing them to behave like metallic conductors. This kind of doping can be achieved without altering the molecular structure of the CNTs if certain chemicals are adsorbed onto the surface of the CNT molecules. High electrical conductivity in Galvorn fibers is achieved using this technique: small amounts of dopant chemicals are present within the packed CNT structure. The addition of these dopants increases the conductivity of the material to approximately 3-4 times the value it would have if it were composed of CNTs with no added chemicals. The dopant in Galvorn fibers and films is stable at room temperature and is not affected even at moderately elevated temperatures (up to around 100° C.). However, if the material is held at temperatures much higher than 100° C., the dopant chemicals will begin to evaporate away from the CNT structure. Once this happens, the resistance of the material will undergo a permanent increase. The extent of that increase will depend on the temperature that was reached and the length of time that the sample remained in the heat. A Galvorn fiber will lose a fraction of its conductivity if it is heated to temperatures between 100° C. and 220° C. and will experience a much more significant loss of conductivity if it is heated to 250° C. or higher. A few minutes of heating at around 300° C. or higher is enough to remove most of the dopants. In order to remove the dopants completely, it is necessary to anneal the material at 500° C. for at least 4 hours in an inert environment in order to avoid oxidizing the CNTs. Such an annealing leads to an irreversible increase in resistance that can range to 400%. Galvorn CNT fibers do not have a temperature coefficient of resistance that is absolutely well-defined when they are first used. When Galvorn is exposed to high or low temperatures the extent to which its resistance will change depends on how much it has been heated, and for what length of time; that change may not be linear or reversible. However, the conductivity of Galvorn materials will have a predictable behavior as a function of temperature, if the Galvorn sample has been heated at temperatures around 500° C. or higher in an inert atmosphere, in which case all of the doping agent will be removed without oxidative damage to the CNTs themselves. A Galvorn fiber that has been annealed in this manner has a temperature coefficient of resistance around 0.0012/° C. (about one quarter that of copper).

There still is a need of improvements of anemometers having a hot-wire probe made of a carbon nanotube fiber.

### SUMMARY OF THE INVENTION

Various embodiments relate to an anemometer comprising two prongs, each prong having a prong tip, and a hot-wire probe attached to the two prong tips and made of a section of a carbon nanotube fiber having an electric resistivity of not more than 25 μΩ·m and a positive thermal coefficient of resistivity of at least 1·10⁻³/K. Over an active length extending between the two prong tips, the hot-wire probe consists of the carbon nanotube fiber, and ends of the section of the carbon nanotube fiber extending along the prong tips are soldered to the prong tips.

Additional embodiments relate to a method of producing an anemometer. The method comprises providing two prongs of metal, the prongs having prong tips, coating the prong tips with solder, carving an indentation into the solder on each of the prong tips, obtaining a section of a carbon nanotube fiber having an electric resistivity of not more than 25 μΩ·m and a positive thermal coefficient of resistivity of at least 1·10⁻³/K, spanning the section of the carbon nanotube fiber between the prong tips and through the indentations, and embedding ends of the section of the carbon nanotube fiber extending through and beyond the indentations in the solder on the prong tips.

Other features and advantages of the present invention will become apparent to one with skill in the art upon examination of the following drawings and the detailed description. It is intended that all such additional features and advantages be included herein within the scope of the present invention, as defined by the claims.

### BRIEF DESCRIPTION OF THE DRAWINGS

The invention can be better understood with reference to the following drawings. The components of the drawings are not necessarily to scale, emphasize instead being placed upon clearly illustrating the principles of the present invention. In the drawings, like reference numerals designate corresponding parts throughout the several views.

FIG. 1 shows an exemplary embodiment of the hot-wire anemometer.

FIG. 2, at an enlarged scale, shows two prong tips and a hot-wire probe attached thereto, the two prong tips being depicted out of two different radial viewing directions.

FIG. 3 is a flow chart of a method of producing the hot-wire probe according to FIG. 2, and

FIG. 4 shows voltage-velocity curves for three different CNF hot wire probe and one platinum hot-wire probe provided as a comparison example.

### DETAILED DESCRIPTION

According to the present disclosure, an anemometer comprises two prongs, each prong having a prong tip, and a hot-wire probe attached to the two prong tips. The hot-wire probe, over its active length extending between the two prong tips, consists of a carbon nanotube fiber. The carbon nanotube fiber has an electric resistivity of not more than 25 μΩ·m and a positive thermal coefficient of resistivity of at least 1·10⁻³/K. All electric resistivities indicated here relate to room temperature. Due to the positive thermal coefficient of resistivity, the electric resistivity will increase with increasing temperature as it is the case with most metals.

The hot-wire anemometer according to the present disclosure makes use of a carbon nanotube fiber of a rather low electric resistivity, particularly if compared to D. Wang et al., supra. This allows to operate the hot-wire anemometer with a much lower voltage applied across the hot-wire probe. In other words, the relative change of the electric resistance of the hot-wire probe occurs at a much lower absolute electric resistance of the hot-wire probe and may thus be determined much easier. As a consequence, the electric and electronic components which have to be provided for operating the hot-wire probe can be provided at lower cost. With a same diameter as the hot-wire probe of Wang et al., i.e. 20 μm, and a length of hundred times the diameter, i.e. 2 mm, the absolute electric resistance of the hot-wire probe of the anemometer according to the present disclosure will be less than 160Ω, i.e., smaller by at least one order of magnitude.

One should clearly differentiate between carbon fibers in general and the carbon nanotube fiber used in the hot-wire anemometer according to the present disclosure, see https://www.tandfonline.com/doi/abs/10.1080/15583724.2016.1169546.

The hot-wire probe may be additionally be attached to each of the prongs for a second time to increase the electric conductivity between the hot-wire probe and the prongs. This additional attachment may be made to another part of the prongs than their prong tips.

Ends of a section of the carbon nanotube fiber which extend beyond the active length of the hot-wire probe may extend along the prong tips and may be soldered or glued to the prong tips with an electrically conductivity solder or glue. More particularly, the ends may extend along the prong tips within solder on side faces of the prong tips facing away from the hot wire probe. In a particular embodiment of the anemometer according to the present disclosure, the prongs may be made of stainless steel. The stainless steel prong tips may be tinned, and the ends of the section of the carbon nanotube fiber may be embedded in Sn-based solder applied to the tinned prong tips. This embedding ensures both a good mechanical and a good electrical connection of the ends of the section of the carbon nanotube fiber to the prong tips made of stainless steel which, as such, are hard to solder.

In an embodiment of the anemometer according to the present disclosure the carbon nanotube fiber has an electric resistivity of not more than 2.5 μΩ·m so that the absolute electric resistance of the hot-wire probe of the anemometer according to the present disclosure will be smaller by at least two orders of magnitude than that one of the hot-wire probe of Wang et al.

Further, the carbon nanotube fiber may have a positive thermal coefficient of resistivity of at least 2·10⁻³/K. Raw materials for carbon nanotube fibers having these properties and being suitable for making hot-wire probes are commercially available, like, for example, from DexMat, supra. Suitability of a carbon nanotube fiber for a hot-wire probe means that its electric resistivity at a certain temperature remains constant, even if the hot-wire probe is cycled through a large range of temperatures several times. Otherwise a calibration of the anemometer would get lost soon. Thus, it is not sufficient to search for a carbon nanotube fiber of a particularly low electric resistivity. It is at least as important to search for a carbon nanotube fiber of a high thermal stability.

As a consequence, the carbon nanotube fiber used for the hot-wire probe of the anemometer according to the present disclosure may be acid-doped and/or acid-treated to increase its electrical conductivity. Particularly, the carbon nanotube fiber may be wet spun from a coagulated solution of carbon nanotubes dissolved in chlorosulfonic acid as known from N. Behabtu et al., supra. However, the carbon nanotube fiber obtained in this way may not directly be used for a hot-wire probe, because it will contain volatile dopants which will be released during the thermal cycles to which a hot-wire probe is subjected. Thus, all volatile dopants in the starting material have to be removed by annealing the carbon nanotube fiber at a sufficient temperature of at least 400° C. for a sufficient period of at least three hours. Typically, all volatile acid dopants will be removed after annealing at 500° C. for four hours, resulting in a thermally stabile material suitable as a hot-wire probe. It is to be understood, that, during the annealing, the carbon nanotube fiber should be kept under an anhydrous and oxygen-free atmosphere.

In the anemometer according to the present disclosure, the carbon nanotube fiber as such makes up the hot-wire probe over the entire active length of the hot-wire probe. This implies that the carbon nanotube fiber, over the active length of the hot-wire probe, is not coated with any electrical conductor. It may be completely uncoated. Further, it is at least free of elemental metal forming an electric conductor. The carbon nanotube fiber may be free of any elemental metal or even free of any metal.

In the anemometer according to the present disclosure, the carbon nanotube fiber and thus the hot-wire probe may have a diameter of not more than 20 μm. In an embodiment, the diameter of the carbon nanotube fiber is in range of 5 μm to 15 μm, i.e., about 10 μm.

The active length of the hot-wire probe may be in a typical range from 0.2 to 5 mm or in a smaller range from 0.5 to 2 mm. The quotient of the active length divided by the diameter will typically be at least 100 in order to leave the flow whose velocity is measured as unaffected as possible.

A method according to the present disclosure of producing the anemometer according to the present disclosure comprises the step of obtaining a section of a carbon nanotube fiber having an electric resistivity of not more than 25 μΩ·m and positive thermal coefficient of resistivity of at least 1·10⁻³/K. The method further comprises the steps of coating prong tips of two metal prongs with solder, carving an indentation into the solder at both prong tips, spanning the section of the carbon nanotube fiber between the prong tips and through the indentations, and embedding ends of the section of the carbon nanotube fiber extending through and beyond the indentations in the solder on the prong tips. More particularly, the ends embedded in the solder may extend along the prong tips on side faces of the prong tips facing away from the respective other prong tip.

As already pointed out before with respect to the anemometer according to the present disclosure, the prongs may be made of stainless steel, the prong tips may be tinned, and that the ends of the section of the carbon nanotube fiber may be embedded in a tin-based solder.

The section of the carbon nanotube fiber may be obtained by the steps of dissolving carbon nanotubes in chlorosulfonic acid to obtain a solution, coagulating the solution by diluting the chlorosulfonic acid to obtain a coagulate, wet spinning the coagulate to obtain a raw carbon nanotube fiber, annealing the raw carbon nanotube fiber at a temperature of at least 400° C. for at least two hours in an anhydrous and oxygen-free atmosphere to obtain a thermally stabilized annealed carbon nanotube fiber, and cutting the section from the annealed carbon nanotube fiber. As compared to the raw carbon nanotube fiber, the annealed carbon nanotube fiber will have a considerably reduced electric conductivity, and even its positive thermal coefficient of resistivity may be reduced. This, however, has to be accepted in order to obtain a thermally stable carbon nanotube fiber suitable for making a hot-wire probe of a hot-wire anemometer.

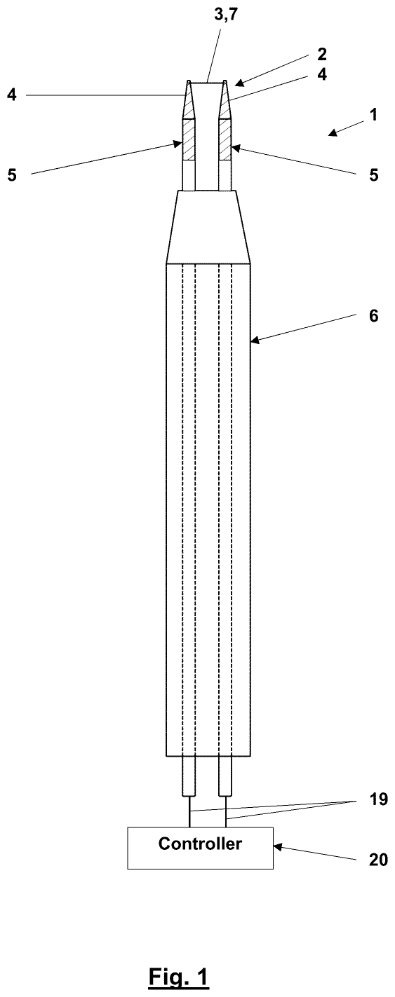

Referring now in greater detail to the drawings, the hot wire anemometer 1 depicted in FIG. 1 comprises a sensor 2 electrically connected to a controller 20. The sensor 2 has a hot-wire probe 3. The hot-wire probe 3 is attached to two prong tips 4 of two parallel prongs 5. The prongs 5 made of metal protrude from a socket 6 made of an electrically insulating material like plastics or ceramics. By means of the socket 6, the hot-wire probe 3 of the sensor 2 is placed in a fluid flow with the hot-wire probe 3 being orientated perpendicular to the main flow direction in order to measure the flow velocity at the position of the hot-wire probe 3. The flow-velocity is measured in that the controller 20, via the prongs 5, directs an electric current through the hot-wire probe 3 in order to heat up the hot-wire probe 3, and varies a voltage applied across the hot-wire probe 3 in order to maintain a constant current through the hot-wire probe 3 or to keep the hot-wire probe 3 at a constant temperature. According to the present disclosure, the hot-wire probe 3 is made of a carbon nanotube fiber 7 of a typical diameter of 5 to 20 μm and with a typical active length between the prong tips 4 of at least hundred times its diameter, i.e. in a range between 0.5 mm and a few millimeters.

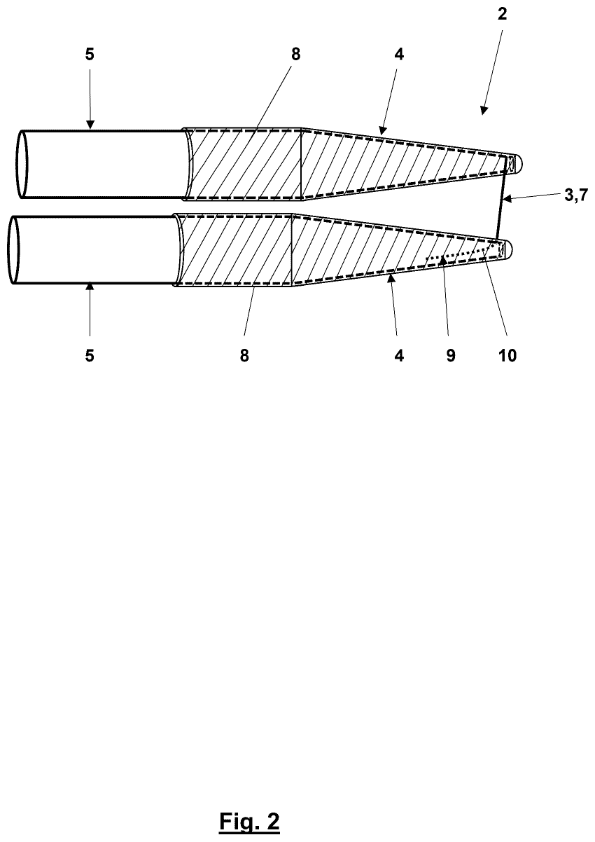

FIG. 2 illustrates how the carbon nanotube fiber 7 of the hot wire probe 3 is attached to the prong tips 4. For this purpose, the upper prong tip 4 in FIG. 2 is actually shown in a viewing direction perpendicular to the linear extension direction of the hot wire probe 3, whereas the lower prong 5 is shown in a viewing direction in this linear extension direction looking on that side of the prong 5 facing away from the hot wire probe 3. Both prong tips 4 are covered with solder 8. The carbon nanotube fiber 7 enters into the solder 8 and extends over the front side of the prong tips 4 as shown at the top of FIG. 2. On the side faces of the prong tips 4 facing away from the hot wire probe 3, as shown at the bottom of the FIG. 2, ends 9 of a section 10 of the carbon nanotube fiber 7 extend along the prong tips 4 within the solder 8. Thus, the carbon nanotube fiber 7 is both mechanically and electrically securely connected to the prong tips 4.

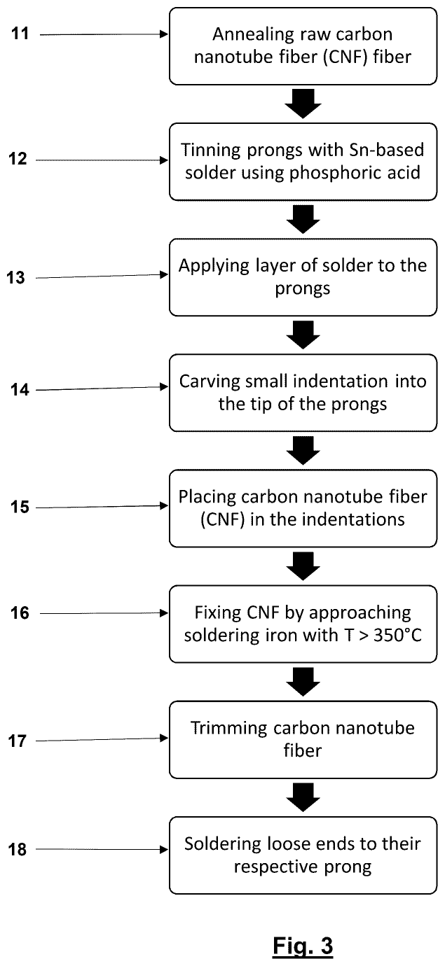

FIG. 3 illustrates a method of producing the sensor 2 according to FIGS. 1 and 2 starting from two prongs 5 made of stainless steel and fixed in the socket 6. In a first step 11 a commercially available raw carbon nanotube fiber like “Galvorn CNT-HS Fiber 10 microns” from DexMat, Houston, Texas, USA is annealed for four hours at 500° C. in order to stabilize its thermal properties, particularly its temperature dependent electric resistivity. In a step 12 the prong tips 4 of the prongs 5 are tinned with a tin based solder using phosphoric acid in order to be able to coat the prong tips 4 with solder suitable for holding and contacting the carbon nanotube fiber. This solder which is also tin based is then applied to the prong tips 4 in a step 13.

Next, in a step 14, small indentations are carved into the solder 8 on the prong tips 4 of the prongs 5 across the front faces of the prong tips 4 as shown on top of FIG. 2. Next, in a step 15, the section 10 of the carbon nanotube fiber 3 is placed in these indentations. In a step 16 the carbon nanotube fiber is fixed in the indentations by approaching a soldering iron at a temperature of up to 350° C. In a step 17, the carbon nanotube fiber is trimmed such that only the ends 9 according to the bottom of FIG. 3 extend beyond the indentations. Finally, in a step 18, these ends 9 of the section 10 of the carbon nanotube fiber 7 are soldered to the respective prong tip 4.

The raw carbon nanotube fiber from which the method according to FIG. 3 starts may be produced according to the method known from N. Behabtu et al., supra.

### Working Example

Raw carbon nanotube fibers (CNFs) are produced from bulk-grown carbon nanotubes (CNTs) by high throughput wet spinning. The carbon nanotubes are dissolved in chlorosulfonic acid in order to form a spinnable liquid crystal dope. The dope is extruded through a spinneret into a coagulant to remove the acid. The formed carbon nanotube fiber filament is collected onto a winding drum. The carbon nanotube fibers are washed with water to remove the solvent. However, traces of the acid stay inside the carbon nanotube fiber and act as a dopant. After washing, the carbon nanotube fibers are dried in an oven. The resulting carbon nanotube fibers are micrometric in diameter (10 to 100 μm) and several centimeters long. They not only possess the electric and heat conductivity of CNTs, but also have the strength of carbon fibers.

Actually, the raw CNF for the hot-wire probe 3 of FIGS. 1 and 2 was commercially acquired from DexMat, supra, with a nominal diameter of 10 μm. As recommended by the manufacturer, the raw CNF was annealed at 500° C. for at least 4 hours, actually 150000 seconds (4 hours and 10 minutes), in an N₂ atmosphere, i.e., in an oxygen-free and anhydrous environment, to thermally stabilize the electric properties of the CNF without oxidizing the CNF.

The prongs 5 to which the carbon nanotube fiber 7 was soldered afterwards were those of a 55P11 DANTEC hot-wire sensor, with its original sensing element removed. The 55P11 sensor comprises of two 20 mm long stainless steel prongs whose prong tips 4 are spaced 1.25 mm apart. The prongs 5 are held by a 1.9 mm diameter ceramic tube body, with gold connectors at the other end. These gold connectors allow for connecting the hot-wire sensor to a 200 mm probe support, which is connected to the controller 20 via a coaxial cable of variable length (1 to 20 m) providing the connector lines 19.

In order to electrically connect the annealed CNF 7 to the prongs 5 of the 55P11 sensor, the stainless steel prongs 5 were at first tinned with standard Sn-based solder using phosphoric acid as a flux agent. Then a lead free, Sn-based solder (C-Solder purchased from GoodFellow GmbH) which contained 93.2% Sn, 3.6% Ag, 2.5% Ni and 0.7% Cu was used to solder the CNF 7 onto the tinned stainless steel prongs 5. The soldering was carried out at a temperature of 300° C. using a temperature controlled soldering iron station. After soldering, the CNT 7 was cut using standard hairdresser's scissors. Finally, the remaining loose ends 9 were soldered onto the respective prong tip 4 to improve both adhesion and electric conductivity.

A high robustness of the CNF was observed during the manufacturing process, where the CNF was routinely tugged by tweezers. Furthermore, the wire had to be tensed when being cut, as otherwise the scissors would only deform it. As an informal experiment, a thin syringe needle was passed in between the prongs 5 of the 55P11 sensor 2 with the soldered CNF 7 in order to let the weight of the sensor 2 hang on the CNF 7. The CNF 7 did not break, and the electric resistance of the hot-wire probe 3 remained unchanged. The same experiment with the original DANTEC 55P11 sensor 2 resulted in a broken wire. In another test, silica particles of various sizes (gravel) were dropped from a height of approximately 50 cm onto the CNF hot-wire probe 3. The impacts of the particles on the CNF hot-wire probe 3 did not change its electric resistance of 13.6Ω.

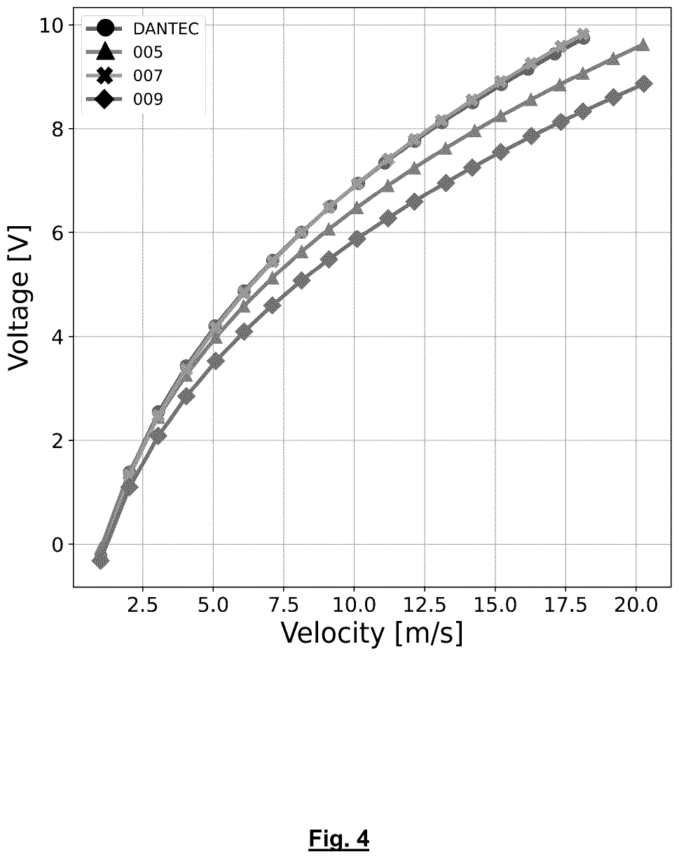

FIG. 4 shows the dependency of the voltage that was needed to keep a current through the hot-wire probe 3 of less than 70 mA constant on the velocity of an airflow in which the sensor 2 was arranged for three CNF 7 samples 005, 007 and 009, diameter 10 μm, active length 1.00 to 1.12 mm, and the original 55P11 DANTEC hot-wire sensor having a platinum hot-wire probe. The similarities of all four curves indicate that all three CNF 7 samples are suitable hot-wire probes 3 which can be operated with the equipment of the original 55P11 DANTEC hot-wire sensor. The three samples of the annealed CNF 7 displayed an average temperature coefficient of resistivity (CTR) of above 2.0·10⁻³/K, i.e. of at least 2.1·10⁻³/K or even of about 2.5·10⁻³/K depending on the method of estimating the TCR from the data presented in FIG. 4. This is a much higher CTR than expected from the product information supplied by DexMat. The highest cut off frequency response of the hot-wire probe 3 obtained was 99 kHz and its mean cut off frequency was 95 KHz. This value is higher than the frequency range of 82 kHz of the 55P11 DANTEC hot-wire sensor.

Many variations and modifications may be made to the preferred embodiments of the invention without departing substantially from the spirit and principles of the invention. All such modifications and variations are intended to be included herein within the scope of the present invention, as defined by the following claims.

We claim:

1. An anemometer comprising
two prongs, each prong having a prong tip, and
a hot-wire probe attached to the two prong tips and made of a section of a carbon nanotube fiber having an electric resistivity of not more than 25 μΩ·m and a positive thermal coefficient of resistivity of at least 1·10⁻³/K,
wherein the hot-wire probe, over an active length extending between the two prong tips, consists of the carbon nanotube fiber, and
wherein ends of the section of the carbon nanotube fiber extending along the prong tips are soldered to the prong tips.

2. The anemometer of claim 1, wherein side faces of the prong tips are coated with solder, and wherein the ends of the section of the carbon nanotube fiber extending along the prong tips are embedded within the solder on the side faces of the prong tips.

3. The anemometer of claim 2, wherein the side faces of the prong tips, on which the ends of the section of the carbon nanotube fiber extending along the prong tips are embedded within the solder, face away from the active length of the hot wire probe.

4. The anemometer of claim 1, wherein the prongs are made of stainless steel.

5. The anemometer of claim 1, wherein the prong tips are tinned.

6. The anemometer of claim 2, wherein the prong tips are tinned, and wherein the solder is a tin-based solder.

7. The anemometer of claim 1, wherein the carbon nanotube fiber has at least one of an electric resistivity of not more than 2.5 μΩ·m and a positive thermal coefficient of resistivity of at least 2·10⁻³/K.

8. The anemometer of claim 1, wherein the carbon nanotube fiber is at least one of acid-doped and acid-treated.

9. The anemometer of claim 1, wherein the carbon nanotube fiber, over the active length of the hot-wire probe, is at least one of uncoated and free of elemental metal.

10. The anemometer of claim 1, wherein the carbon nanotube fiber has a diameter of not more than 20 μm.

11. The anemometer of claim 1, wherein the carbon nanotube fiber has a diameter in a range from 5 μm to 15 μm.

12. The anemometer of claim 1, wherein the active length of the hot-wire probe is in a range from 0.2 to 5.0 mm.

13. The anemometer of claim 1, wherein the active length of the hot-wire probe is in a range from 0.5 to 2.0 mm.

14. A method of producing an anemometer, the method comprising:
providing two prongs of metal, the prongs having prong tips,
coating the prong tips with solder,
carving an indentation into the solder on each of the prong tips,
obtaining a section of a carbon nanotube fiber having an electric resistivity of not more than 25 μΩ·m and a positive thermal coefficient of resistivity of at least 1·10⁻³/K,
spanning the section of the carbon nanotube fiber between the prong tips and through the indentations, and
embedding ends of the section of the carbon nanotube fiber extending through and beyond the indentations in the solder on the prong tips.

15. The method of claim 14, wherein the ends embedded in the solder extend along the prong tips on side faces of the prong tips facing away from the respective other one of the prong tips.

16. The method of claim 14, wherein the step of providing includes making the prongs of stainless steel.

17. The method of claim 14, further comprising, prior to the step of coating, tinning the prong tips.

18. The method of claim 17, wherein the step of coating includes coating the prong tips with a tin-based solder, and wherein the step of embedding includes embedding the ends of the section of the carbon nanotube fiber in the tin-based solder.

19. The method of claim 14, wherein the step of obtaining includes
dissolving carbon nanotubes in chlorosulfonic acid to obtain a solution,
coagulating the solution by diluting the chlorosulfonic acid to obtain a coagulate, and
wet spinning the coagulate to obtain a raw carbon nanotube fiber.

20. The method of claim 19, wherein the step of obtaining further includes
annealing the raw carbon nanotube fiber at a temperature of at least 400° C. for at least 2 hours in an anhydrous and oxygen-free atmosphere to obtain an annealed carbon nanotube fiber, and
cutting the section of the carbon nanotube fiber from the annealed carbon nanotube fiber.
